(19) United States
(12) Patent Application Publication
(10) Pub. No.: US 2014/0002260 A1
(43) Pub. Date: Jan. 2, 2014

(54) Apology Stick

(71) Applicant: Elta Wright, Queens Village, NY (US)

(72) Inventor: Elta Wright, Queens Village, NY (US)

(21) Appl. No.: 13/914,604

(22) Filed: Jun. 10, 2013

Related U.S. Application Data
(60) Provisional application No. 61/689,587, filed on Jun. 8, 2012.

(51) Int. Cl. B60Q 1/26

(52) U.S. Cl. CPC B60Q 1/26
USPC 340/468

(57) ABSTRACT

The invention provides a remote controlled and driver operated flashing sign that fastens by suction cups to a rear glass of a car, van, pickup or SUV. When activated by the driver, The Apology Stick flashes a friendly waving hand along with the words I'm Sorry. The Apology Stick is an electronic sign, powered either by batteries or wiring into a vehicular electrical system. Activation and deactivation of The Apology Stick occurs as the driver presses and then releases an On and Off switch on the remote. The Apology Stick also incorporates a second message of Thank You to credit other motorists for acts of driving courtesy.

### CLAIM OF PRIORITY

This patent application claims priority under 35 USC 119 (e) (1) from U.S. Provisional Patent Application Ser. No. 61/689,587 filed Jun. 8, 2012, of common inventorship herewith entitled, “The Apology Stick.”

### FIELD OF THE INVENTION

The present invention pertains to the field of electronic signs, and more specifically to the field of electronic signs for vehicles.

### BACKGROUND OF THE INVENTION

The prior art has put forth several designs for electronic signs for vehicles. Among these are:

U.S. Pat. No. 4,574,269 to Gregory R. Miller describes a visual communicator for a rear window of a vehicle. The communicator is semi transparent and adapted to be disposed in the rear window of the vehicle for viewing from outside of the vehicle. The degree of transparency is such as to accommodate normal use of an inside rearview mirror of the vehicle by a driver of the vehicle. The communicator also includes a message display unit including a plurality of light emitting diodes comprising in a matrix arrangement and disposed in a limited discrete portion of the rear window. The light emitting diodes are selectively energizable to emit light in the form of a message. The communicator further includes a message control unit operationally interconnected to the light emitting diodes for selectively energizing the light emitting diodes. The message control unit is programmed to energize the light emitting diodes in any one of a plurality of preselected patterns.

U.S. Pat. No. 6,282,823 to Leo Brown describes a driver courtesy device including a first unit attachable to the dashboard or steering console of an automobile, within reach of the driver of the automobile, and a display unit mounted adjacent the rear window or one of the side windows of the automobile. The first unit includes a signal transmitter actuated by the driver. The display unit includes an upstanding member resembling an arm and hand, a signal receiver, and a motor actuated for a predetermined operational period upon receipt of the signal transmitted by the first unit. An interposer converts rotary motion of the actuated motor to linear motion to thereby move the arm and hand in a reciprocating, waving motion to convey a courteous gesture.

U.S. Pat. No. 7,233,849 to Danny Lee Hill and Debra Hill describes an automobile communication system for communicating with others by displaying operator selected or input messages on a display mounted in the rear window of a vehicle. The operator may select messages on a keypad or by voice commands received by a microphone mounted in the vehicle. The system may include predetermined messages and may be programmed to include additional messages for display.

None of these prior art references describe the present invention.

### SUMMARY OF THE INVENTION

It is an object of the present invention to provide an electrical sign installable in a vehicle conveying an apology to other drivers.

### BRIEF DESCRIPTION OF THE DRAWINGS

FIG. 1 is a prototypical front view of the present invention suctioned to a vehicular rear window.

FIG. 2 is a prototypical front view showing a remote control adhered to a vehicular dashboard.

FIG. 3 is a prototypical illustrative front diagonal view showing a remote control button and an illuminated apology sign with suction cups and a hand that blinks and moves side to side imitating a hand wave.

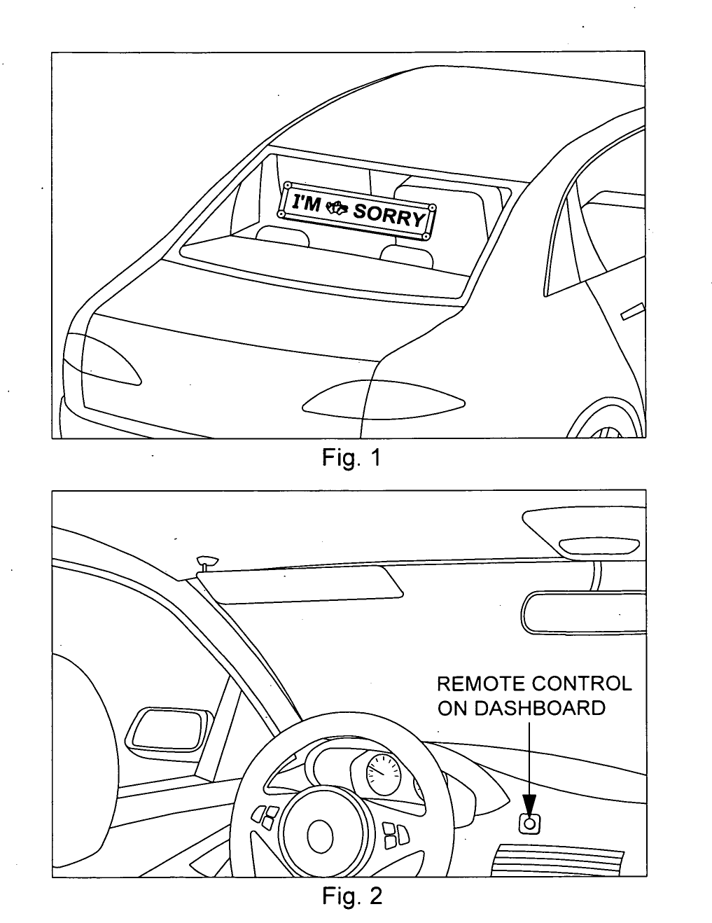

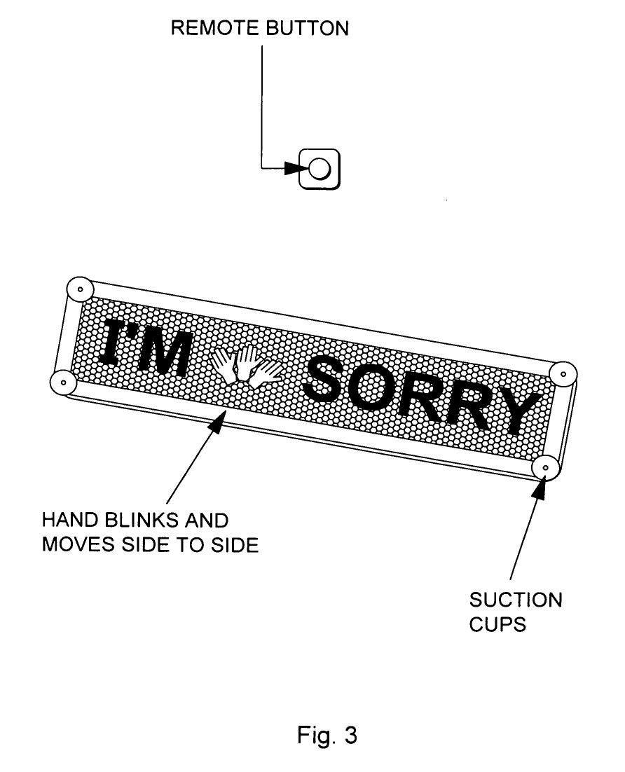

### DETAILED DESCRIPTION OF THE INVENTION

Inventions are always a product of vision and creativity, whether they are world changing inventions like cars or computers or everyday conveniences like pump hairsprays, cordless tools or resealable soda bottles. Some inventions present an entirely new product like a cell phone and such an invention changes the way we live. Other inventions such as a snow scraper and brush combine two existing tools or products into one tool, reduce clutter in one's environment and make one's chores easier to perform. Some inventions deal with common problems such as roll on deodorants dealing with body odors and other inventions like the automobile bring a new form of convenience when they come into existence. Many inventions consist of relatively small but highly effective improvements of existing products or technologies. Inventions come in so many categories, and sometimes necessity or sometimes creativity is the mother of invention. Somewhere, someone is combining their own vision, imagination and creativity to create something that will improve, or even revolutionize, our lives. Most inventions fill a relatively small need or perform a specialized and limited function. If that need or functionality is shared by a sufficient number of consumers, the invention has a great potential for success. Many people experience road rage, either as perpetrators or as victims. Road rage is aggressive or angry behavior by a driver that includes, rude gestures, verbal insults, deliberately driving in an unsafe or threatening manner or making threats. Road rage leads to altercations, assaults, collisions, injuries and even deaths. Road rage happens to anyone. A motorist is driving along, their attention wanders for a split second and they cut another driver off. Most people, most of the time, can handle such incidents, but some people go berserk. Two people make a fight, so experts advise the best way to handle aggressive behavior is to ignore it. An even better idea is to acknowledge one's mistake and apologize for it.

The present invention, hereinafter referred to as The Apology Stick, is a remote controlled and driver operated flashing sign that fastens by suction cups to a rear glass of a car, van, pickup or SUV. When activated by the driver, The Apology Stick flashes a friendly waving hand along with the words I'm Sorry. The Apology Stick is an electronic sign, powered either by batteries or wiring into a vehicular electrical system. The Apology Stick is available as an aftermarket accessory or a factory installed piece of standard or optional safety equipment. The Apology Stick is rectangular in shape and measures approximately ten and one half inches in length by two and one half inches in width by one inch in depth. The front of the sign faces outward, is positioned in the rear glass of the vehicle, and held in place by four suction cups situated in its four corners. The aftermarket Apology Stick is accompanied by a remote control unit that is powered by one or two AAA cell batteries. This remote control also includes a peel n stick adhesive backing, so the control is mounted in a permanent accessible site convenient to a driver. The factory installed Apology Stick includes a dash mounted control switch. The letters of the words I'm Sorry display in highly visible bold red. In between these two words, a flashing and waving hand displays in highly visible yellow. Activation and deactivation of The Apology Stick occurs as the driver presses and then releases an On and Off switch on the remote. The Apology Stick also incorporates a second message of Thank You to credit other motorists for acts of driving courtesy.

The Apology Stick is designed to, defuse roadway situations that may lead to incidents of road rage, situations such as improper merges and lane changes or driving too slow in the passing lane.

Easily mounted and operated with touching a remote control, The Apology Stick provides motorists with a simple and inexpensive means of displaying courtesy on a roadway and perhaps stop an incident of road rage before it starts.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An electronic sign installable in a vehicle conveying an apology to other drivers, comprising: a remote controlled and driver operated flashing sign that fastens by suction cups to a rear glass of a car, van, pickup or SUV, wherein the flashes a friendly waving hand along with the words “I'm Sorry” when a remote button is activated by a driver.

2. The electronic sign of claim 1, powered either by batteries or wiring into a vehicular electrical system.

3. The electronic sign of claim 1, available as an aftermarket accessory or a factory installed piece of standard or optional safety equipment.

4. The electronic sign of claim 1, wherein the sign is rectangular in shape and measures approximately ten and one half inches in length by two and one half inches in width by one inch in depth, wherein the front of the sign faces outward, is positioned in the rear glass of the vehicle, and held in place by four suction cups situated at the four corners of the sign.

5. The electronic sign of claim 1, wherein the sign is suited for aftermarket applications and is accompanied by a remote control unit that is powered by one or two AAA cell batteries, and wherein the remote control also includes a peel and stick adhesive backing.

6. The electronic sign of claim 1 further comprising wherein the flashes a friendly waving hand along with the words “Thank You” when a remote button is activated by a driver.
